(19) United States
(12) Patent Application Publication
(10) Pub. No.: US 2025/0076882 A1
(43) Pub. Date: Mar. 6, 2025

(54) METHOD AND DEVICE FOR REMOTE CONTROL OF THE MOVEMENT OF A VEHICLE

(71) Applicant: Ford Global Technologies, LLC, Dearborn, MI (US)

(72) Inventors: Andreas Puetz, Kelmis (DE); Mohamed Benmimoun, Aachen (DE); Lars Kuhnert, Köln (DE); Tobias Lotz, Bergisch Gladbach (DE); Thomas Nowak, Aldenhoven (DE); Benjamin Maus, Düsseldorf (DE)

(73) Assignee: Ford Global Technologies, LLC, Dearborn, MI (US)

(21) Appl. No.: 18/788,607

(22) Filed: Jul. 30, 2024

(30) Foreign Application Priority Data
Aug. 28, 2023 (DE) 102023123075.1

(51) Int. Cl. G05D 1/223; B60W 50/00; G05D 1/222; H04W 4/40

(52) U.S. Cl. CPC G05D 1/223; G05D 1/2235; H04W 4/40; B60W 2050/0064

(57) ABSTRACT

A method for remotely controlling the movement of a vehicle by means of a hand-held device is described. The method includes the following steps: activating a button by pressing and holding the button by a user; setting a tilt angle of the device by the user starting from an initial tilt angle when activating the button; receiving a signal representing the current tilt angle of the device; converting the received signal into a virtual pedal position, which corresponds to the position of a physical pedal corresponding to the virtual pedal; controlling the movement of the vehicle according to the virtual pedal position; and stopping the vehicle if pressing and holding the button is ended.

### CROSS-REFERENCE TO RELATED APPLICATIONS

The present application claims priority to and the benefit of German Application No. 102023123075.1, filed on Aug. 28, 2023, which is hereby incorporated by reference herein in its entirety.

### FIELD

The present invention relates to a method and device for remotely controlling the movement, in particular the longitudinal movement, of a vehicle, for example a motor vehicle, by means of a hand-held device, for example by means of a mobile device. The invention also relates to a vehicle.

### BACKGROUND

Precisely maneuvering a vehicle at low speeds in situations with road conditions that are difficult to assess, especially with friction of the road surface that is difficult to estimate, and/or with nearby surrounding objects can be very challenging for a user—in the following only the male variant will be used for better readability. This applies in particular to a fully loaded vehicle and/or with a trailer attached. An example situation is pulling a trailer loaded with a boat out of the water. In such situations, users often use the help of other people outside the vehicle to navigate. The outside person typically monitors the movement of the vehicle from the outside, in particular by observing the vehicle from different positions, and provides the user with feedback information, for example by voice or hand signals. However, such help is not always available. In this case, it would be useful if the user could take on both roles. This requires remote control of the vehicle, which allows the user to move freely around the vehicle outside the vehicle, while the vehicle is controllable from the respective position.

Comparable assistance functions are known for parking situations in which a user can leave the vehicle before it is automatically parked into a parking space, for example a narrow one. The longitudinal and lateral movement of the vehicle is controlled by a driver assistance function.

According to current legislation for driver assistance systems, a user must monitor the automatic parking maneuver. This is done, for example, by confirming monitoring by either drawing a specific pattern on a display or by pressing a button on a hand-held device that is electronically coupled to the vehicle, for example via Bluetooth. However, this user confirmation is binary, i.e. the confirmation or non-confirmation depends on the quality of the input signal entered by the user. In the situation described above, a user typically operates in much smaller increments, if not continuously, to control the vehicle using the control units of the vehicle, such as the brake pedal, acceleration pedal, and steering wheel. Often, users apply very little pressure to the accelerator pedal or release the brake pedal only very slightly to observe whether the vehicle reacts as expected. It is therefore desirable if a hand-held device used for remote control would reflect this process.

Documents US 11 648 976 B2 and US 2022/0 179 410 A1 disclose systems and methods for remotely controlling the movement of a vehicle and a trailer by means of a mobile device. A change in the tilt angle of the mobile device is used for control. Document US 2023/0 128 580 A1 describes a method of remotely parking a vehicle using a mobile device. Document EP 3 284 651 B1 discloses a method for remotely maneuvering a motor vehicle using a mobile device.

### SUMMARY

Against the background described, the object of the present invention is to provide an advantageous method and a control device for remotely controlling the movement of a vehicle by means of a hand-held device, as well as an advantageous vehicle. These objects are achieved by a method for remotely controlling the movement of a vehicle according to the disclosed embodiments, a control device for remotely controlling the movement of a vehicle according to disclosed embodiments and by a vehicle according to disclosed embodiments. The disclosed embodiments contain further advantageous embodiments of the invention.

The method according to the invention for remote control of the movement, in particular the longitudinal movement, of a vehicle, for example a motor vehicle, by means of a hand-held device includes the following steps. In a first step, a button, for example an activation button, is activated by pressing and holding the button by a user. In other words, a button is pressed by a user and held down permanently. This can be done, for example, on a display of the device.

In a next step, the user adjusts a tilt angle of the device starting from an initial tilt angle when activating the button, for example. When activating the button, a signal can be detected that represents the initial tilt angle. In a further step, a signal is received that represents the current, for example the set, tilt angle. In this context, in particular the current tilt angle of the device can be detected.

In a further step, the received signal is converted into a virtual pedal position, which corresponds to the position of a physical or real pedal corresponding to the virtual pedal. For example, the pedal can be an acceleration pedal or a brake pedal. The movement of the vehicle is then controlled according to the virtual pedal position. In other words, the vehicle is controlled as it would be if the physical pedal corresponding to the virtual pedal were pressed accordingly. In the case of an acceleration pedal, when the tilt angle of the device is increased, the vehicle moves as if an accelerator pedal were being pressed down according to the tilt angle. In the case of a brake pedal, a reduction in the tilt angle of the device would correspond to a corresponding release of the brake and the vehicle would react in the same way as for a corresponding release of the brake pedal.

If pressing and holding the button is stopped, i.e. if the button is released or the holding is interrupted, the vehicle is stopped, preferably stopped immediately. This is very advantageous from a safety point of view.

The hand-held device is preferably a mobile device, such as a mobile phone, tablet, netbook, smartwatch, etc.

The method according to the invention has the advantage that no second person is required to navigate the vehicle and a user can assume the role of both the driver and the person that is navigating. In addition, possible misunderstandings between a navigating person and the user are avoided. This improves the safety associated with the navigation of a vehicle and increases the comfort for a user.

Preferably, the pedal position is an acceleration pedal position or a brake pedal position. The tilt angle can be determined in relation to a specified axis, for example a longitudinal axis or a transverse axis, of the device.

In an advantageous variant, an initial tilt angle of the device can be determined, for example detected, when the button is activated. This can be done by means of the device. A tilt angle adjusted or set by the user can then be determined, for example detected. The tilt angle difference between the initial tilt angle and the adjusted tilt angle can be determined, detected or calculated, for example. The tilt angle difference as a signal can be converted into a virtual pedal position, i.e. in particular a position of an acceleration pedal or a brake pedal.

The speed of the vehicle and/or the torque of a drive motor of the vehicle may be kept below a specified maximum value while the method is being carried out. This improves safety for persons or objects in the vicinity of the vehicle while the method is being carried out. In particular, it ensures that the vehicle can only move below a specified speed during the navigation process.

Optionally, the vehicle can be controlled laterally by means of a driver assistance function. For example, the vehicle can be controlled laterally along a specified or predetermined trajectory using the driver assistance function. This can be done, for example, along a straight line or while maintaining a specified steering angle or along road markings. The user can specify a trajectory by drawing the trajectory on a display that shows the current environment of the vehicle. For this purpose, a camera-based image of the current environment of the vehicle can be shown on the display.

In another variant, the vehicle can be stopped if the distance of the vehicle from the device and/or at least one detected object and/or at least one detected person falls below a specified minimum distance. In this context, the immediate surroundings of the vehicle can be detected and evaluated, for example by means of sensors, especially cameras. This ensures a high level of safety when carrying out the method.

Furthermore, an all-wheel drive of the vehicle can be activated or deactivated before moving the vehicle. This has the advantage that this option, which is otherwise available when controlling the vehicle from the driver's seat, is also available to the user during the remote control.

The control device according to the invention for remote control of the movement, in particular the longitudinal movement, of a vehicle by means of a hand-held device, preferably a mobile device, contains a hand-held device with an activation button, for example in the form of a pressable button on a display, and a device for detecting a signal representing the current tilt angle of the device. For example, the device for detecting the signal that represents the current tilt angle of the device can be a sensor, for example a gravity sensor. It is advantageous to use the gyroscope that is usually installed in mobile devices to implement other functions

The control device according to the invention also contains an evaluation device for receiving a signal representing the current tilt angle and for converting the received signal into a virtual pedal position that corresponds to a position of a physical pedal corresponding to the virtual pedal. The control device also contains a device for transmitting data from the evaluation device to a vehicle control system for controlling the movement, in particular for controlling the longitudinal movement, of the vehicle depending on the detected tilt angle of the device, i.e. corresponding to a virtual pedal position. The control device according to the invention is designed to carry out a method already described for remote control of the movement of a vehicle by means of a hand-held device. The control device has the features and advantages already described in this context.

The vehicle according to the invention contains a control device according to the invention described above. It has the same features and benefits as this. The vehicle can be, for example, a motor vehicle or a ship. The motor vehicle can be a passenger car, a truck, a bus or a minibus.

### BRIEF DESCRIPTION OF THE DRAWINGS

The invention is explained in more detail below by means of exemplary embodiments with reference to the attached figures. Although the invention is illustrated and described in detail by the preferred exemplary embodiments, the invention is not limited by the disclosed examples and other variations can be inferred by the skilled person without departing from the scope of the invention.

The figures are not necessarily true to detail and to scale and may be enlarged or scaled down to provide a better overview. Therefore, functional details disclosed here are not to be understood in a restrictive way, but merely as a descriptive basis which provides guidance to the person skilled in this field of technology to use the present invention in a variety of ways.

The term “and/or” used herein, when used in a series of two or more elements, means that each of the listed elements can be used alone, or any combination of two or more of the listed elements can be used. For example, if a composition containing components A, B and/or C is described, the composition may contain A alone; B alone; C alone; A and B in combination; A and C in combination; B and C in combination; or A, B, and C in combination.

FIG. 1 schematically shows a mobile device for carrying out a method according to an embodiment of the invention.

FIG. 2 schematically shows a first variant of a method according to an embodiment of the invention in the form of a flow diagram.

FIG. 3 schematically shows a second variant of a method according to an embodiment of the invention in the form of a flow diagram.

FIG. 4 schematically shows a control device according with an embodiment of the invention.

FIG. 5 schematically shows a vehicle according with an embodiment of the invention.

### DETAILED DESCRIPTION

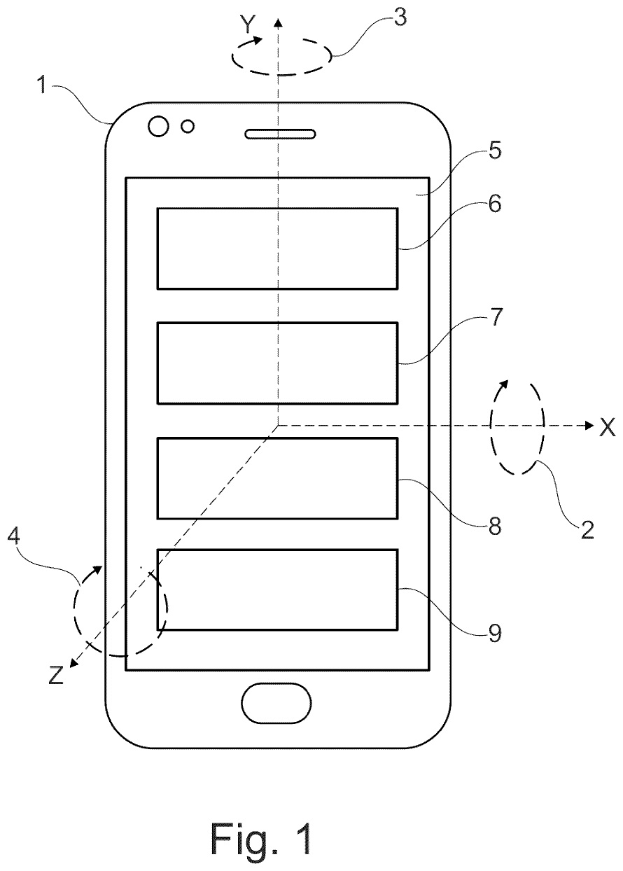

FIG. 1 shows schematically a mobile device for carrying out a method according to the invention. In the example shown, it is a mobile phone. FIG. 1 defines three axes with respect to the mobile device, an x-axis, a y-axis, and a z-axis. By rotating the mobile device 1 around the x-axis, the tilt angle is changed. This is indicated by an arrow 2. When the mobile device 1 rotates around the y-axis, the swivel angle is changed. This is indicated by an arrow 3. When the mobile device 1 rotates around the z-axis, the roll angle is changed. This is indicated by an arrow 4.

The mobile device 1 contains a display 5. There are several buttons on the display 5, which are designed to be pressed. Button 6 shown as an example is a button for deactivating the remote control. Button 7 is a button for pressing an acceleration pedal. Button 8 is a button for releasing a brake pedal. The optional button 9 is a button for activating an all-wheel drive.

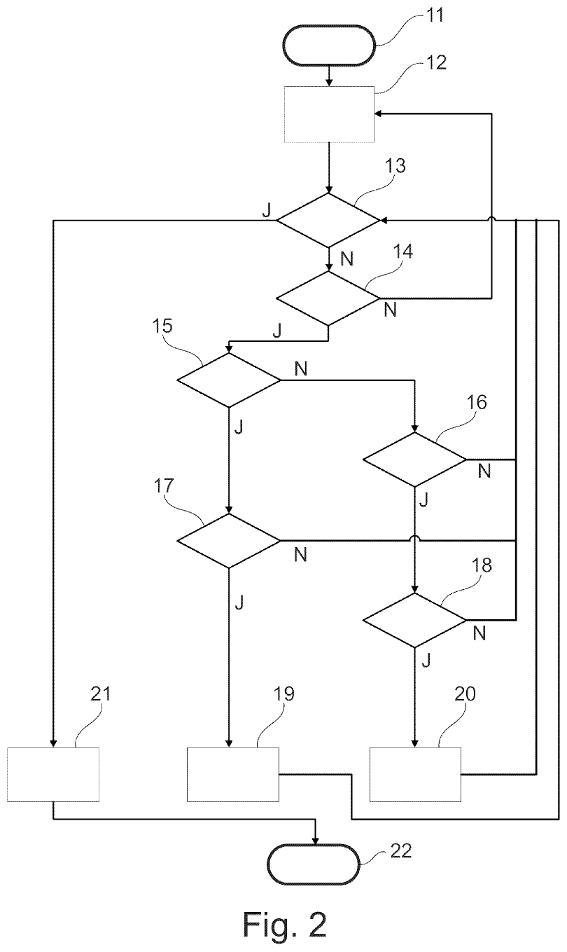

FIG. 2 schematically shows a first variant of a method according to the invention in the form of a flow diagram. In this variant, a virtual acceleration pedal is operated by means of the mobile device and a vehicle is remotely controlled accordingly.

In step 11, the method is started. For this purpose, a corresponding control system is started by a user. In step 12, the vehicle locks the brakes of the vehicle, i.e. fully engages them so that the vehicle does not move. In step 13 a check is made of whether a button to deactivate the remote control, such as button 6 shown in FIG. 1, is pressed. If this is the case, in step 21 the vehicle will continue to lock the brakes, i.e. fully engage them, so that the vehicle cannot move. The method is then ended in step 22, for example by deactivating the control system.

If the deactivation button 6 is not pressed in step 13, in step 14 a check is made of whether a button for the virtual operation of an acceleration pedal, for example button 7 shown in FIG. 1, is held down. If this is not the case, the method jumps back to step 12. If this is the case, in step 15 a check is made of whether the tilt angle 2 of the mobile device 1 is increased. If this is the case, the method is continued with step 17. If this is not the case, the method is continued with step 16.

If the tilt angle is increased in step 15, in step 17 a check is made of whether the vehicle speed is below a specified limit, such as a speed limit for low speeds. The limit value can be a maximum of 10 km/h, in particular a maximum of 5 km/h. If the vehicle speed is below the limit value, the drive motor torque is increased in step 19 and the method is continued in step 13. If the vehicle speed is not below the limit value, the method jumps directly back to step 13.

If the tilt angle is not increased or raised in step 15, in step 16 a check is then made of whether the tilt angle is reduced. If this is not the case, the method jumps back to step 13. If this is the case, in step 18 a check is made of whether the drive motor torque is greater than zero. If this is not the case, the method jumps back to step 13. If this is the case, i.e. the drive motor torque is greater than zero, the drive motor torque is reduced in step 20 and the method is then continued with step 13.

In the context of steps 15 and 16, the tilt angle of the mobile device 1 is detected in each case, for example starting from an initial tilt angle when pressing a button to operate an acceleration pedal, for example button 7 in FIG. 1. An evaluation device of a control device for carrying out the method receives a signal that represents the tilt angle and converts the received signal into a virtual pedal position, in this example into an acceleration pedal position. The drive motor torque is then increased or reduced according to the virtual pedal position. The vehicle is moved by means of the drive torque controlled in this way.

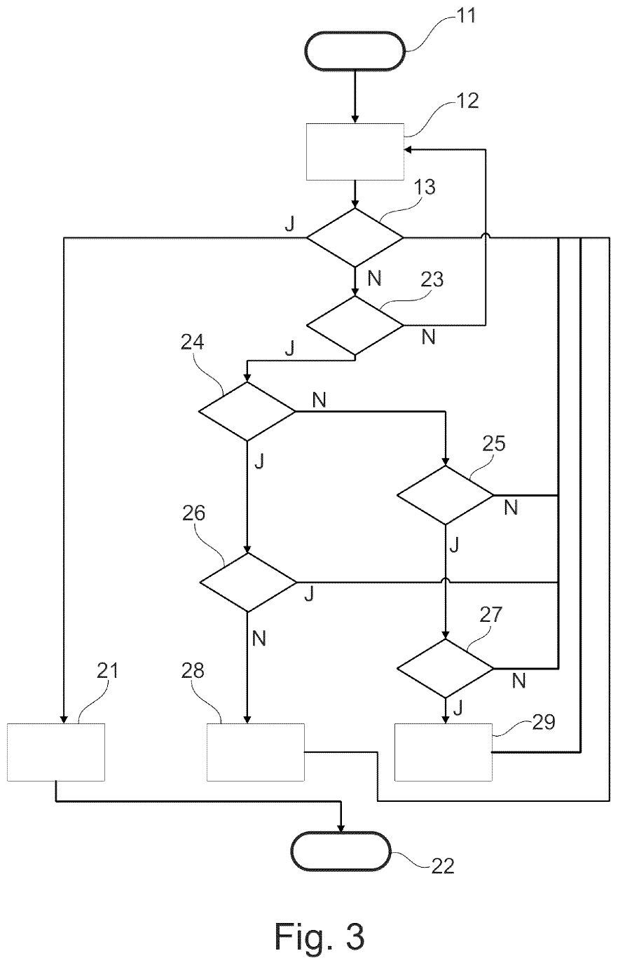

FIG. 3 schematically shows a second variant of a method according to the invention in the form of a flow diagram. In this variant, a virtual brake pedal is operated by means of the mobile device and a vehicle is remotely controlled accordingly.

Steps 11, 12, 13, 21 and 22 correspond to the steps shown in FIG. 2 and described in this context. In this regard, reference is therefore made to the description of FIG. 2. If the deactivation button is not pressed in step 13, in step 23 a check is made of whether a button for virtually releasing a brake, for example button 8 shown in FIG. 1, is held down. If this is not the case, the method jumps back to step 12. If this is the case, in step 24 a check is made of whether the tilt angle of the mobile device is raised or increased. If this is not the case, the method is continued with step 25. If this is the case, the method is continued with step 26.

In step 26 a check is made of whether the brakes are locked or fully engaged, i.e. whether the brakes are fully applied. If this is the case, the method jumps back to step 13. If this is not the case, the brake pressure is increased in step 28 and the method is then reset to step 13.

If the tilt angle of mobile device 1 is not increased in step 24, in step 25 a check is made of whether the tilt angle is decreased. If this is not the case, the method jumps back to step 13. If this is the case, in step 27 a check is made of whether the vehicle speed is below a specified limit and whether the brake pressure is greater than zero. If this is not the case, the method jumps back to step 13. If this is the case, the brake pressure is reduced in step 29. In other words, the brake is released in the same way as a corresponding operation of a physical brake pedal.

In the context of steps 24 and 25, the tilt angle of the mobile device 1 is detected in each case, for example starting from an initial tilt angle when pressing a button to operate or release a brake pedal, for example button 8 in FIG. 1. An evaluation device of a control device for carrying out the method receives a signal that represents the tilt angle and converts the received signal into a virtual pedal position, in this example into a brake pedal position. The brake pressure is then increased or reduced according to the virtual pedal position. The vehicle is moved by means of the brake pressure controlled in this way, i.e. allowed to roll.

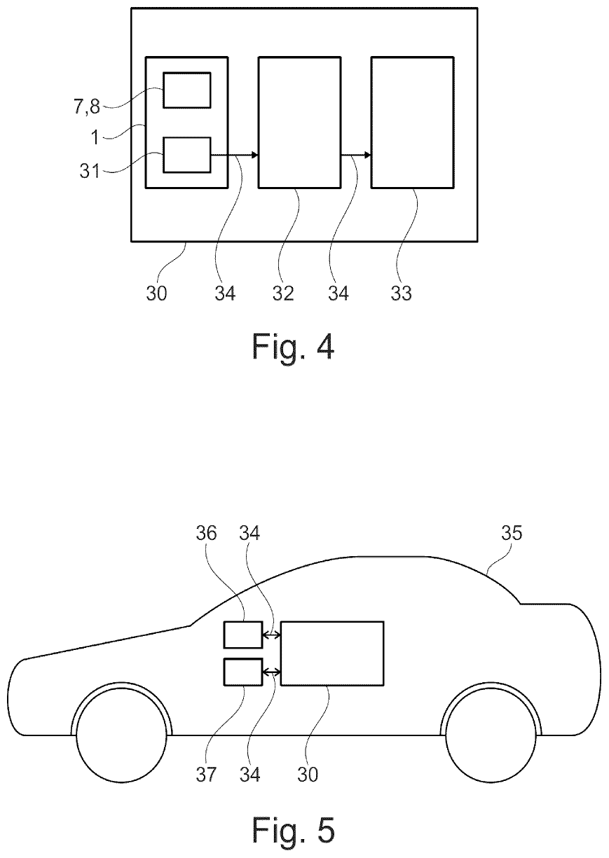

FIG. 4 schematically shows a control device 30 according to the invention. The control device 30 may be a mobile device 1, for example a mobile phone shown in FIG. 1, and include computer hardware and software. The mobile device 1 has at least one button 7, 8 for operating a pedal. The button can be, for example, a button 7 to operate an acceleration pedal or a button 8 to operate, especially to release, a brake pedal. The mobile device 1 also has a device 31, for example a corresponding sensor, for detecting a signal that represents the current tilt angle of the device.

The control device 30 also has an evaluation device 32 for receiving a signal representing the current tilt angle and for converting the received signal into a virtual pedal position corresponding to a physical pedal corresponding to the virtual pedal. The signal transmission from the device 31 for detecting a signal representing the current tilt angle of the mobile device to the evaluation device 32 is indicated by an arrow 34. The evaluation device 32 can be integrated into mobile device 1 or can be integrated into the vehicle to be controlled.

The control device also contains a device 33 for data transmission of data from the evaluation device 32 to a vehicle control system for controlling the movement, in particular the longitudinal movement, of the vehicle depending on the detected tilt angle of the mobile device corresponding to a virtual pedal position. In other words, the device 33 is designed to transmit data to a control system for the drive torque and/or the brake pressure.

FIG. 5 schematically shows a vehicle 35 according to the invention. The vehicle contains a control device according to the invention, for example a control device 30 shown in FIG. 4. The vehicle 35 also contains a device for controlling the drive torque 36, for example an acceleration pedal, and a device for controlling the brake pressure 37, for example a brake pedal, each of which is connected to the control device 30 for signal transmission 34, in particular to the device for data transmission 33.

### LIST OF REFERENCE SIGNS

1 Mobile device
2 Tilt angle
3 Pivot angle
4 Roll angle
5 Display
6 Button for deactivating the remote control
7 Button for pressing an accelerator pedal
8 Button for releasing a brake pedal
9 Button for activating an all-wheel drive
10 Start, activate control system
11 Locking the brakes
12 Button for deactivating the remote control pressed?
13 Button for the virtual operation of an acceleration pedal held down?
14 Tilt angle of the mobile device increased?
15 Tilt angle of the mobile device reduced?
16 Vehicle speed below specified limit?
17 Drive motor torque>0?
18 Increase drive motor torque
19 Reduce drive motor torque
20 Locking the brakes
21 End, deactivate control system
22 Button for virtually releasing a brake held down?
23 Tilt angle of the mobile device increased?
24 Tilt angle of the mobile device reduced?
25 Brakes locked?
26 Vehicle speed below a specified limit and brake pressure greater than zero?
27 Increase brake pressure
28 Reduce brake pressure
29 Control device
30 Device for detecting a signal representing the current tilt angle of the device
31 Evaluation device
32 Data transmission device
33 Signal transmission
34 Vehicle
35 Device for controlling the drive torque
36 Device for controlling the brake pressure
J yes
N no
x Coordinate axis
y Coordinate axis
z Coordinate axis

1. A method for remotely controlling movement of a vehicle by a hand-held device, comprising the steps of:
detecting activation of a button of the device that was pressed and held by a user;
setting a tilt angle of the device based on an initial tilt angle when the button is being activated;
receiving a signal representing a current tilt angle of the device;
converting the received signal into a virtual pedal position, which corresponds to the position of a physical pedal corresponding to the virtual pedal;
controlling movement of the vehicle according to the virtual pedal position; and
stopping the vehicle when the button is no longer being pressed and held.

2. The method according to claim 1, wherein the pedal position is an acceleration pedal position or a brake pedal position.

3. The method according to claim 1, further comprising the steps of:
determining an initial tilt angle when activating the button;
determining a tilt angle adjusted by the user;
determining the tilt angle difference from the initial tilt angle and the adjusted tilt angle; and
converting the tilt angle difference as a signal into a virtual pedal position.

4. The method according to claim 1, wherein the tilt angle is determined with respect to a specified axis of the device.

5. The method according to claim 1, wherein at least one of a speed of the vehicle or a torque of a drive motor of the vehicle is kept below a specified maximum value.

6. The method according to claims 1, wherein the vehicle is controlled laterally by means of a driver assistance function.

7. The method according to claim 6, wherein the vehicle is controlled laterally along a specified trajectory by means of the driver assistance function.

8. The method according to claim 1, wherein the vehicle is stopped when a distance between the vehicle and one or more of the device, at least one detected object, or at least one detected person falls below a specified minimum distance.

9. The method according to claim 1, wherein before movement of the vehicle, an all-wheel drive of the vehicle is activated or deactivated.

10. A control device for remote control of movement of a vehicle, comprising:
a hand-held device having a button which can be activated by pressing and holding and a device for detecting a signal representing a tilt angle of the device;
an evaluation device for receiving a signal representing the tilt angle and for converting the received signal into a virtual pedal position corresponding to a position of a physical pedal corresponding to the virtual pedal; and
a device for transmitting data from the evaluation device to a vehicle control system for controlling movement of the vehicle depending on the tilt angle of the device.

11. The control device according to claim 10, wherein the control device performs the following steps:
detect activation of a button of the control device that was pressed and held by a user;
set a tilt angle of the control device based on an initial tilt angle when the button is being activated;
receive a signal representing the tilt angle of the control device;
convert the received signal into a virtual pedal position, which corresponds to the position of a physical pedal corresponding to the virtual pedal;
control movement of the vehicle according to the virtual pedal position; and
stop the vehicle when the button is no longer being pressed and held.

12. The control device of according to claim 10, wherein the pedal position is an acceleration pedal position or a brake pedal position.

13. The control device of according to claim 10, further comprising the steps of:
determining a second tilt angle when activating the button;
determining a tilt angle adjusted by a user;
determining a tilt angle difference from the second tilt angle and the adjusted tilt angle; and
converting the tilt angle difference as a signal into a virtual pedal position.

14. The control device of according to claim 10, wherein the tilt angle is determined with respect to a specified axis of the device.

15. The control device of according to claim 10, wherein at least one of a speed of the vehicle or a torque of a drive motor of the vehicle is kept below a specified maximum value.

16. The control device of according to claim 10, wherein the vehicle is controlled laterally by means of a driver assistance function.

17. The control device of according to claim 16, wherein the vehicle is controlled laterally along a specified trajectory by means of the driver assistance function.

18. The control device of according to claim 10, wherein the vehicle is stopped when a distance between the vehicle and one or more of the device, at least one detected object, or at least one detected person falls below a specified minimum distance.

19. The control device of according to claim 10, wherein before movement of the vehicle, an all-wheel drive of the vehicle is activated or deactivated.
